(19) United States
(12) Patent Application Publication
(10) Pub. No.: US 2023/0271664 A1
(43) Pub. Date: Aug. 31, 2023

(54) MOTORIZED KICK SCOOTER

(71) Applicant: Taur Technologies Limited, Horsham, West Sussex (GB)

(72) Inventors: Carson BROWN, Horsham, West Sussex (GB); Richard ADEY, Horsham, West Sussex (GB); John DESMOND, Horsham, West Sussex (GB)

(21) Appl. No.: 18/007,453

(22) PCT Filed: Jul. 30, 2021
(86) PCT No.: PCT/GB2021/051979

§ 371 Date: Jan. 30, 2023

(30) Foreign Application Priority Data
Jul. 31, 2020 (GB) 2011976.4

(51) Int. Cl. B62K 3/00; B62J 25/04; B62J 6/00

(52) U.S. Cl. CPC B62K 3/002; B62J 6/00; B62J 25/04; B62K 2204/00

(57) ABSTRACT

A motorized kick scooter having a foot platform arrangement comprising two foot platforms that each have a length no greater than 600 mm, and support a user on a foot platform surface, for which a distance between the ground surface and itself is less than a diameter of a rear wheel. The foot platforms are also positioned to partly overlap the rear wheel and so that a fore end of each foot platform is positioned between a front wheel and the rear wheel and to be positioned either equidistant between the front and rear wheels or more proximate to the rear wheel. The two foot platforms are positioned either side of the rear wheel.

### FIELD OF THE INVENTION

The present invention relates to the field of kick scooters, and in particular to motorized kick scooters.

### BACKGROUND OF THE INVENTION

Motorized kick scooters are effectively a “kick scooter” or “stand-up scooter” with a motorized wheel that provides propulsive power. To operate the motorized kick scooter, a user typically stands upright upon a foot platform and controls a speed via a user input interface (e.g. a throttle lever or twistgrip). A motorized kick scooter should be distinguished from “motor scooters” or simply “scooters”, which are a type of motorcycle comprising a seat. Thus, motorized kick scooters are usually seatless.

Typically, a motorized wheel for a motorized kick scooter comprises a petrol/gas motor or an electric motor, which is controlled in response to a user input to drive a wheel. Recent trends indicate that electric kick scooters, comprising an electric motor, are more popular than those comprising a petrol/gas motor, as they are more environmentally friendly, easier to control and less dangerous in use.

There has been an increasing interest in the use of motorized kick scooters within urban environments, e.g. cities or towns, to provide a cheap and simple way for quick transportation about urban environments.

There is an ongoing desire to improve the safety and versatility of motorized kick scooters.

### SUMMARY OF THE INVENTION

The invention is defined by the claims.

The present disclosure relates to concepts for positioning a rider/user on a motorized kick scooter. In particular, it is recognized that the weight of the rider/user can be controlled through appropriate configuration of the foot platform(s). Appropriate positioning of the weight of the rider/user towards the scooter can advantageously improve traction of the wheels of the scooter, e.g. to avoid front/rear wheel lift during acceleration/deceleration.

According to examples in accordance with an aspect of the invention, there is provided a motorized kick scooter for transporting a user across a ground surface.

The motorized kick scooter comprises: a front wheel; a rear wheel, wherein at least one of the front and rear wheels are motorized; a lower framework coupling the front wheel to the rear wheel; a handle arrangement configured to support a hand of the user and facilitate control of a direction of the front wheel with respect to the lower framework; and a foot platform arrangement coupled to the lower framework, the foot platform arrangement comprising: a first foot platform configured to support a first foot of the user on a first foot platform surface, the first foot platform being positioned on a first side of the rear wheel; a second, separate foot platform configured to support a second foot of the user on a second foot platform surface, the second foot platform being positioned on a second, different side of the rear wheel.

Each foot platform: has a length of no more than 600 mm; is positioned to overlap only a part of the rear wheel; is positioned such that a distance between the ground surface and the foot platform surface of each foot platform, whilst the motorized kick scooter is transporting a user across the ground surface, is less than a diameter of the rear wheel; is positioned such that at least a first part of each foot platform, being a part of a foot platform closest to the front wheel, lies between the front wheel and the rear wheel; and is positioned such that a distance between the first part of each foot platform and the front wheel is more than or equal to the distance between the first part of each foot platform and the rear wheel.

The distance between the first part of each foot platform and the front/rear wheel may be a horizontal distance, i.e. a distance in a horizontal plane.

In particular, the distance between the first part of each foot platform and the front wheel may be a distance between a vertical plane in which a rearmost part of the front wheel lies and a vertical plane in the first part of the foot platform lies. Similarly, the distance between the first part of the foot platform and the rear wheel may be a distance between the vertical plane in which the first part of the foot platform lies and a vertical plane in which the frontmost or foremost part of the rear wheel lies.

Optionally, each foot platform is positioned such that such that a distance between the first part of each foot platform and the front wheel is between 1 and 2 times greater than the distance between the first part of each foot platform and the rear wheel, and preferably between 1 and 1.5 times greater than the distance between the first part of each foot platform and the rear wheel.

In the context of the present disclosure, the term “first part” may be replaced by any of the terms “fore part”, “first end” or “fore end” for improved clarity.

The proposed motorized kick scooter allows the scooter to define or more accurately predict the position of the user (when they are riding the scooter) with respect to the other components of the motorized kick scooter. In other words, the foot platforms can define a dedicated position for riding the scooter. This reduces the variability of positions in which a rider could position themselves, resulting in predictable ride dynamics. Predictable ride dynamics means that the balance and traction of the scooter can be kept substantially constant, facilitating new, more flexible and/or less complex control mechanisms for operating the scooter.

The present disclosure further recognizes that traction is affected by the weight distribution on the motorized kick scooter. In particular, changing the rider’s position adjusts the front and rear wheel traction, which has an impact on the braking ability of each wheel, as well as their torque transmission capability. Thus, control of the position of the user allows the position of the weight of the user to be anticipated, meaning that traction of the motorized kick scooter can be appropriately configured based on the anticipated location of the user’s weight.

Moreover, braking or deceleration of a scooter is more efficient if both front and rear wheels remain in contact with the ground surface during a braking procedure, to reduce the chances of skidding (e.g. and is particularly efficient if braking is performed using both wheels). However, due to the change of momentum during braking or deceleration, the rear wheel unloads and the front wheel is loaded. It is recognized that placing a bigger bias on (e.g. positioning the user’s weight towards) the rear wheel would reduce the chances of the rear wheel lifting during braking, thereby reducing the chances of skidding and allowing both wheels to decelerate quickly without losing traction. It will also be appreciated that a lifting of the back wheel can, in some circumstances, lead to the motorized kick scooter tipping forward (e.g. under heavy deceleration).

However, it is also recognized that, during acceleration of a motorized kick scooter, the jerk causes rider weight to shift to the rear. Thus, if the user’s weight is positioned too far to the back of the motorized kick scooter, then the front wheel may lift. Lifting of the front wheel may result in an unloading of the front wheel, i.e. a loss of traction, if (only) the front wheel is motorized or a “wheelie” if (only) the rear wheel is motorized. Both of these results are undesirable during normal operation.

The present disclosure proposes an approach to appropriate placement of the user to provide a good compromise between positioning of the weight between the front and rear of the motorized kick scooter. In particular, the possible positions of the user’s weight are limited by the size and placement of the foot platforms. Thus, the scooter of the present disclosure can reduce the chances of both the rear wheel lifting during braking, and the front wheel lifting during acceleration. Thus, traction during acceleration/braking can be improved, and the risk of tipping the motorized kick scooter can be reduced.

A first example positions the foot platforms to partly overlap the rear wheel and positions the foot platforms so that a fore end of each foot platform lies between the front and rear wheels, and is either equidistant between the front and rear wheels or closer to the rear wheel than the front wheel. This ensures that the user’s weight can only be positioned closer to the rear wheel of the motorized kick scooter than to the front wheel, whilst not being entirely over the rear wheel.

The proposed embodiments also use two dedicated platforms positioned either side of the rear wheel. This approach increases a stability of the user on the scooter because it more closely resembles the natural stable human standing position (e.g. compared to conventional scooters). In particular, it is recognized that humans are more stable with legs apart slightly than with part of the feet (e.g. ankles) touching. Enabling a more natural human standing position also reduces stress on the hips and legs of the user during transportation. Naturally, the hips and legs would attempt to dampen vertical movement of the motorized kick scooter (e.g. due to rough terrain), i.e. effectively act as suspension. Enabling the user to stand with legs slightly apart in the disclosed manner enables the user’s anatomy to act in a natural manner, reducing stress on the user’s anatomy.

Furthermore, having dedicated foot positions informs the user of a safe ride orientation, thereby reducing the likelihood of operator error (e.g. positioning themselves too far to the front of the scooter, which could lead to bucking under heavy braking).

In the context of the present disclosure, the term “overlap ... the rear wheel” is considered to mean an extent to which the foot platform overlaps a side of the rear wheel. Thus, if the foot platforms were moved towards or away from the front wheel, the extent to which they would overlap the rear wheel would change.

Each foot platform may be positioned so that a first (aft) portion of the foot platform overlaps the rear wheel, and a second (fore) portion of the foot platform does not overlap the rear wheel. The second portion of the foot platform may be more proximate to the front wheel than the first portion of the foot platform.

The foot platforms are positioned so that a surface (upon which a user’s foot rests) is below the uppermost part of the rear wheel whilst the user is riding the motorized scooter. This approach lowers the relative center of gravity of the motorized scooter (thereby leading to improved stability and reduced likelihood of unintentional rolling), improves safety (by providing a smaller distance for a user to fall in the event of failure) and increases an ease in mounting and dismounting the motorized scooter.

In some embodiments, each foot platform has a length of no more than 400 mm, and preferably no more than 300 mm. In some embodiments, each foot platform has a length of no less than 100 mm, for example no less than 150 mm or no less than 180 mm.

Each foot platform may be positioned in parallel to the rear wheel.

Arranging the platforms to be parallel to the rear wheel allows the user’s feet to be oriented generally in the direction of travel, which improves a balance of the user on the motorized scooter (as facing a direction of travel is a more natural and stable method of movement). Moreover, this alignment decreases a stress on the user’s legs and hips (which would help dampen vertical movement of the motorized scooter due to roughness in a terrain), as the human body is designed for dampening movement in a forward direction of travel (e.g. to dampen shock whilst running or walking).

This approach is contrary to standard scooter design in which a single narrow platform is used for both feet, so that a user is forced to put one foot in front of the other, or arrange the feet side-by-side in a diagonal angle relative to the direction.

In some examples, the first foot platform is connected to the lower framework via a first folding mechanism, that allows the first foot platform to fold with respect to the lower framework; and the second foot platform is coupled to the lower framework via a second folding mechanism, that allows the second foot platform to fold with respect to the lower framework.

In other words, each foot platform may be foldable against the lower framework of the scooter. Foldable platforms allow for easier transportation and allow the kick scooter to become more compact for carrying or transportation (e.g. have a smaller footprint).

In some embodiments, the lower framework comprises a reinforced support to which the first and/or second foot platforms are coupled.

In further examples, the motorized scooter further comprises a stand operable in: a first mode, in which the stand couples the motorized kick scooter to the ground surface to prevent or reduce a roll of the motorized kick scooter; and a second mode, in which the stand does not couple the motorized kick scooter to the ground surface to allow a roll of the motorized kick scooter, wherein the stand is coupled to the reinforced support of the lower framework.

This embodiment recognizes that the structural support for the first and/or second foot platforms (the reinforced support) provides a good structural point for stabilizing the product when it is not being ridden. This embodiment thereby increases a structural stability of the stand and reduces a likelihood that the stand (or its point of connection to the motorized kick scooter) will break.

Using a shared support for both the stand and the foot platform(s) can reduce the weight of the lower framework, by avoiding the need for a dedicated appendage for mounting the stand and/or using other components to which the stand could be mounted (e.g. a battery unit or the like).

This approach is particularly advantageous if the lower framework does not mount a number of (usually heavy) components, such as a battery, to which the stand may otherwise be connected. This approach can be used to reduce the size and weight of the lower framework.

The stand may comprise a rotating mechanism to allow the stand to rotate between a first orientation, in which the stand operates in the first mode, and a second orientation, in which the stand operates in the second mode.

The stand may be a center stand, so that it supports the motorized kick scooter in an upright/vertical position or orientation when engaged with a ground surface. The stand may be connected to an underside of the lower framework. The stand may comprise two separate support legs, to prevent the motorized kick scooter from falling to either side, i.e. in order to maintain the scooter in an upright or vertical position/orientation.

Optionally, each foot platform has a width of no more than 250 mm. For example, each foot platform may have a width of no more than 150 mm.

Preferably, no more than 80% of each foot platform overlaps the rear wheel. In some examples, no more than 50% of each foot platform overlaps the rear wheel. In other examples, no more than 20% of each foot platform overlaps the rear wheel.

Optionally, no more than 80% of the rear wheel overlaps each foot platform. For example, no more than 50% of the rear wheel overlaps each foot platform. For example, no more than 20% of the rear wheel overlaps each foot platform.

These approaches provide a good compromise between fore and aft positioning for the weight of the user, to further improve the traction and control of the motorized kick scooter.

Preferably, each foot platform is positioned such that a distance between the ground surface and the foot platform surface of each foot platform, whilst the motorized kick scooter is transporting a user across the ground surface, is less than 0.75 times the diameter of the rear wheel.

This approach enhances the effect of lowering the center of gravity, improving safety and ease in mounting/dismounting the motorized kick scooter.

In preferred examples, the distance between the ground surface and the foot platform surface of each foot platform, whilst the motorized kick scooter is transporting a user across the ground surface, is less than 0.6, e.g. less than 0.5 times, the diameter of the rear wheel.

Some embodiments recognize that it may be preferred to have a minimum gap between the ground surface and the foot platform, e.g. to facilitate leaning of the motorized scooter during a turn. As an example, a higher center of gravity increases an ease of leaning the motorized scooter to perform a turn, and a higher position for the foot platform surface can increase the gap between the foot platform and the ground (e.g. to reduce the likelihood that the foot platform will come into contact with the ground surface during a turn).

Accordingly, in some example, the distance between the ground surface and the foot platform surface of each foot platform, whilst the motorized kick scooter is transporting a user across the ground surface, is no less than 0.1 times, e.g. no less than 0.2 times, e.g. no less than 0.35 times the diameter of the rear wheel.

In some examples, the distance between the ground surface and the foot platform surface of each foot platform, whilst the motorized kick scooter is transporting a user across the ground surface, is between 0.1 and 0.75 times, e.g. between 0.35 and 0.6 times, the diameter of the rear wheel. These ranges have been identified as providing a good compromise between maneuverability of the motorized kick scooter and safety (as well as ease of mounting/dismounting).

Preferably, the front wheel is motorized.

In some examples, the motorized kick scooter further comprises a light projection system configured to project light onto a user of the motorized kick scooter.

Projecting light onto a user of the motorized kicks scooter improves the visibility of the user, e.g. at low ambient light levels such as at night or in foggy conditions. A further advantage of the fixed/known position of the user, facilitated by the present disclosure, is that light can be more easily or reliably projected onto the (body of the) user, as their position is known. Thus, the spread of light can be made more narrowly focused, compared to prior art approaches that typically require a broad spread of light to ensure illumination of the rider, to thereby increase an average light incident on the user and thereby increase their visibility.

The motorized kick scooter is preferably seatless.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 is an isometric view of a motorized kick scooter;

FIG. 2 is a top-down view of the motorized kick scooter;

FIG. 3 is a side view of a portion of the motorized kick scooter;

FIG. 4 provides an isometric view of a motorized kick scooter having foldable foot platforms;

FIG. 5 is a ground-level view of a motorized kick scooter having a stand;

FIG. 6 is a side view of the motorized kick scooter having the stand;

FIG. 7 is a side view of a portion of a motorized kick scooter; and

FIG. 8 illustrates a motorized wheel for use in a motorized kick scooter.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the figures are merely schematic and are not drawn to scale. It should also be understood that the same reference numerals are used throughout the figures to indicate the same or similar parts.

According to a concept of the invention, there is proposed a motorized kick scooter having a foot platform arrangement comprising two foot platforms that each have a length no greater than 600 mm, and support a user on a foot platform surface, for which a distance between the ground surface and itself is less than a diameter of a rear wheel. The foot platforms are also positioned to partly overlap the rear wheel and/or so that a fore end of each foot platform is positioned between a front wheel and the rear wheel and to be positioned either equidistant between the front and rear wheels or more proximate to the rear wheel. The two foot platforms are positioned either side of the rear wheel.

Embodiments are at least partly based on the realization that a position of a user with respect to the motorized kick scooter can effectively be controlled through appropriate configuration of the foot platform arrangement. This can allow a position of a center of gravity of the overall vehicle (during transportation of a user) to be controlled and/or predicted in advance, allowing for predictable ride dynamics. This knowledge of the ride dynamics means that the balance and traction of the scooter can be kept substantially constant, facilitating new, more flexible and/or less complex control mechanisms for operating the scooter.

The present disclosure further recognizes that traction is affected by the weight distribution on the motorized kick scooter. Thus, control of the position of the user allows the position of the weight of the user to be anticipated, meaning that traction of the motorized kick scooter can be appropriately configured based on the anticipated location of the user’s weight.

The present disclosure also recognizes a number of other benefits to the proposed positioning of the user with respect to the motorized kick scooter, which are set out in more detail throughout this disclosure.

In the context of this disclosure, a vertical axis/plane is an axis/plane that contains the local gravity direction. A horizontal axis/plane is any axis/plane perpendicular to a vertical plane. A non-inclined ground surface (i.e. a flat ground surface) can be modelled/approximated as lying in a horizontal plane, so that a “horizontal ground surface” is a ground surface that can be modelled/approximated as lying in the horizontal plane. A “horizontal distance” is a distance along a horizontal axis, and a “vertical distance” is a distance along a vertical axis.

In the context of the present disclosure, the terms “rider” and “user” refer to an operator of the motorized kick scooter, and are considered interchangeable. Reference to a “foot” of the user may include a bare foot or a foot wearing footwear (e.g. socks, shoes, boots and the like).

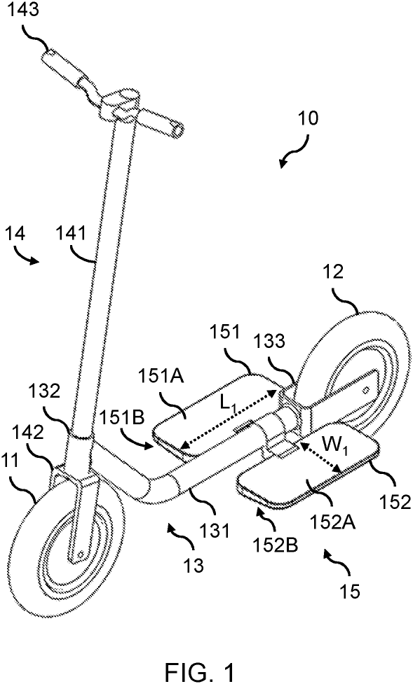

FIG. 1 provides an isometric view of a motorized kick scooter 10 according to an embodiment.

The motorized kick scooter 10 comprises a front wheel 11 and a rear wheel 12. The front wheel 11 and/or the rear wheel 12 is/are motorized. Each wheel may, for example, have a height of between 8 inches to 16 inches (e.g. 200 mm to 410 mm or so). As a working example, each wheel may have a height of 12 inches (around 305 mm). The structure of a wheel will be familiar to the skilled person, and may comprise conventional elements such as a tire, hub, rim etc., although other structures and components could be used.

A lower framework 13 connects or couples the front wheel 11 to the rear wheel 12, for example, using a strut 131 or column that connects the two together (e.g. via one or more forks).

A handle arrangement 14 is provided to support a hand of the user, and allows the user to control a direction of the front wheel 11 about the lower framework 13.

As illustrated, this can be achieved using a steering column 141 (of the handle arrangement 14) that rotates within a support tube 132 of the lower framework 13. The support tube 132 has a generally hollow cylindrical structure that allows the steering column to rotate therein (e.g. using a bearing system or the like). The steering column 141 connects to the front wheel 11 via a fork arrangement 142. A handle 143 allows the user to control the rotation of the steering column 141. This handle arrangement allows the user to control the direction of the front wheel by manually turning the front wheel, using the steering arrangement, in the desired direction of travel.

For the sake of completeness, more complex steering mechanisms are envisaged for use in alternative handle arrangements, such as the use of a steering linkage system or the use of motors to turn the front wheel. The illustrated example provides a simple, reliable and low-cost mechanism for steering the motorized scooter.

It will be clear that, in the illustrated example, the lower framework 13 connects the front wheel 11 to the rear wheel 12 via the fork arrangement 142 for the front wheel, the support tube 132, the strut 131 and a similar fork arrangement 133 for the rear wheel.

The motorized kick scooter 10 also comprises a foot platform arrangement 15, which is coupled to the lower framework 11. The foot platform arrangement 15 is configured to support both feet of the user, to thereby allow the user to ride the motorized kick scooter 10. It will be apparent that the user stands on the foot platform arrangement 15 and uses the handle arrangement 14 to control the direction of travel.

In particular, the foot platform arrangement 15 comprises a first foot platform 151 and a second foot platform 152, each adapted to support a respective foot of the user on a respective foot platform surface 151A, 152A. Thus, the first foot platform 151 comprises a first foot platform surface 151A on which a first foot of the user may be supported, and the second foot platform 152 comprises a second foot platform surface 152A on which a second foot of the user may be supported.

The two foot platforms are positioned to lie either side of the rear wheel, i.e. on opposite sides of the rear wheel. In other words, the rear wheel 12 is disposed between the two foot platforms 151, 152.

The length L₁ of each foot platform 151, 152 is configured to be no greater than 600 mm, e.g. no greater than 500 mm or no greater than 400 mm or no greater than 300 mm. This effectively limits the possible range of positions at which the user may stand on the foot platform arrangement 15, thereby facilitating control over the position of the user with respect to the overall motorized kick scooter 10.

For improved comfort, the length L₁ of each foot platform is preferably no less than 100 mm, for example, no less than 150 mm and more particularly no less than 180 mm. It is recognized that a minimum length of 180 mm match an average length between the heel and the ball(s) of the male foot, to provide a suitable platform for a user to stand on.

However, other suitable minimum sizes may be selected for different versions of the motorized kick scooter (e.g. for children). Thus, the length L₁ of each foot platform is preferably no less than the average length between the heel and ball of the foot of a desired customer group (e.g. males, females, children, adults and so on).

Each foot platform surface 151A, 152A, on which the user is positioned, preferably spans more than 90% of the length of its respective foot platform, e.g. more than 95% of the length of its respective foot platform or (substantially) the entire length of the foot platform.

Once again, for improved comfort, the length of each foot platform surface is preferably no less than 100 mm, for example, no less than 150 mm and more particularly no less than 180 mm. It is recognized that a minimum length of 180 mm match an average length between the heel and the ball(s) of the foot, to provide a suitable platform for a user to stand on.

However, other suitable minimum sizes may be selected for different versions of the motorized kick scooter (e.g. for children). Thus, the length of each foot platform surface is preferably no less than the average length between the heel and ball of the foot of a desired customer group (e.g. males, females, children, adults and so on).

Preferably, a foot platform surface 151A, 152A is a surface designed to support a user’s foot, e.g. be suitably sized and/or made of suitable material for supporting the user’s foot. In particular examples, the foot platform surface may comprise a material or element having a greater grip (for a user’s foot) than other parts of the foot platform.

Thus, in some examples, each foot platform surface 151A, 152A may comprise a grip material or anti-slip material. Suitable materials include rubber, silicone, vinyl, cork and so on. Each foot platform surface may, for example, be textured to improve a grip for supporting a user’s foot or footwear, e.g. in wet conditions. For example, each foot platform surface 151A, 152A may comprise channels or grit for improving a grip on a user’s foot or footwear in at least wet conditions.

In some examples, each foot platform 151, 152 has a width W₁ of no more than 250 mm, for example, a width of no more than 150 mm. These examples, whilst not essential, facilitate further control over the position of the user and therefore the center of mass of the motorized kick scooter during operation.

Each foot platform 151, 152 is positioned to only partly overlap the rear wheel 12. That is, each foot platform is positioned so that only some (and not all) of the foot platform overlaps the rear wheel 12. Preferably, the two foot platforms overlap the rear wheel 12 by (approximately, e.g. ±2% or ±1%) the same amount.

The overlap is identified as the overlap between the side of the foot platform(s) and the side of the rear wheel. The foot platforms 151, 152 are positioned to lie partway between the rear of the rear wheel 12 and the front of the front wheel 11, and are positioned so that only part of each foot platform overlaps the rear wheel.

As illustrated, each foot platform 151, 152 is positioned so that at least a first part or end 151B, 152B of each foot platform, being a part/end of a foot platform closest to the front wheel 11, lies between the front wheel and the rear wheel 12.

In the illustrated example, each foot platform is also positioned such that a distance between the first part/end 151B, 152B of each foot platform and the front wheel is more than or equal to the distance between the first part/end of each foot platform and the rear wheel. Although advantageous for improved positioning of the user, this feature is not essential to the present invention.

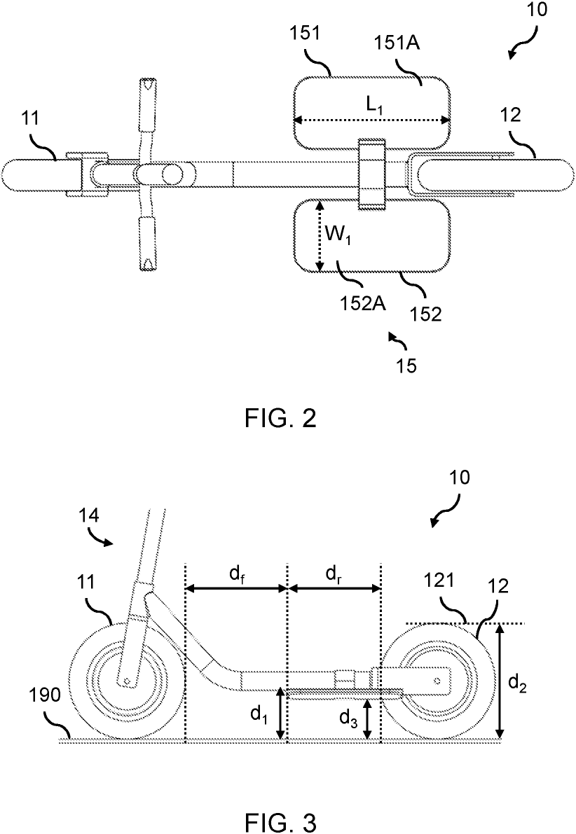

FIG. 2, which provides a top down view of the motorized kick scooter 10, illustrates the overlap between the foot platforms and the rear wheel in more detail. In particular, it can be seen that the rear parts of the foot platforms 151, 152 overlap the rear wheel 12, whereas the fore parts of the foot platforms 151, 152 do not overlap the rear wheel.

FIG. 3, which provides a side view of part of the motorized kick scooter 10, also illustrates this overlap, as well as illustrating a ground surface 190 over which the motorized kick scooter may ride. Some of the handle arrangement 14 has been omitted from FIG. 3 for improved clarity.

Each foot platform 151, 152 is also positioned such that a distance d₁ between the ground surface 190 and the foot platform surface of each foot platform, whilst the motorized kick scooter is transporting a user across the ground surface, is less than a diameter d₂ of the rear wheel. This feature is best illustrated by FIG. 3.

Thus, when standing on the motorized scooter, the sole of the user’s foot or footwear would be below the uppermost part 121 of the rear wheel.

Preferably, as in the illustrated example, the distance d₁ is less than 0.75 times the diameter d₂ of the wheel, more preferably less than 0.6 times the diameter d₂ of the wheel and even more preferably less than 0.5 times the diameter d₂ of the wheel. As a working example, the distance d₁ may be approximately 0.4 times the diameter d₂ of the wheel.

In the illustrated example, each foot platform 151, 152 is parallel with the rear wheel. This configuration allows the user’s feet to be oriented generally in the direction of travel, improving a balance of the user on the motorized scooter 10 and reducing stress on the user’s legs (as a human body is naturally designed for damping movement in a forwards direction).

However, this feature is not essential and the foot platforms 151, 152 may instead be angled with respect to the rear wheel, e.g. inwardly facing (towards the lower framework) or outwardly facing (away from the inner framework). Outwardly facing foot platforms may, for example, provide a more natural and stable standing position for a user of the motorized kick scooter.

The proposed foot platform arrangement 15 allows the motorized kick scooter 10 to effectively control or define a user position with respect to the motorized kick scooter. This can allow for knowledge over the center of mass of the motorized kick scooter to be known or predicted in advance, which can be used to improve a control scheme for the motorized kick scooter. The skilled person would appreciate how a known position for the user allow ride dynamics to be more predictable, allowing for increased ease of control over traction and/or braking of the motorized kick scooter.

Thus, the proposed foot platform arrangement facilitates improved control over the ride dynamics of the motorized kick scooter.

The present disclosure also recognizes that the proposed positioning of the foot platforms provides a good compromise between fore and aft weight distribution, as well as providing a suitably low center of gravity (to avoid unintentional roll) without increasing a difficulty in rolling, to effect a turn, beyond a minimum level of ease for a user.

Moreover, positioning the foot platform surfaces below an uppermost part of the rear wheel reduces a distance between the user and the ground surface, increases safety (by reducing fall height) and increasing an ease in mounting/dismounting the motorized kick scooter.

The present disclosure also recognizes that positioning a user so that they overlap a rear wheel of the motorized kick scooter allows a shorter lower framework, saving material and allowing for a more compact motorized kick scooter. In particular, a user can still be appropriately positioned to comfortably engage with the handle arrangement, even though the lower framework is shorter (e.g. the strut 131 is shorter).

Furthermore, it is recognized that braking is more efficient if both front and rear wheels remain in contact with the ground surface. This reduces the chances of skidding. However, momentum changes during braking cause the rear wheel to unload and the front wheel to load. Placing a bigger bias on (e.g. positioning the user’s weight towards) the rear wheel would reduce the chances of the rear wheel lifting during braking, thereby reducing the chances of skidding and allowing both wheels to decelerate quickly without loss of traction.

However, during acceleration of a scooter, the jerk causes the rider’s weight to shift to the rear. Thus, if the user’s weight is positioned too far to the back of the motorized kick scooter, then the front wheel may lift. This results in a loss of traction of the front wheel, and could (if the jerk is sufficiently large or the rear wheel is motorized) in the complete lifting of the front wheel from the ground surface, i.e. performance of a “wheelie”.

The present disclosure proposes an approach in which the user is positioned to only partly overlap the rear wheel, thus providing a good compromise between positioning of the weight between the front and rear of the motorized kick scooter. Thus, the scooter of the present disclosure can reduce the chances of both the rear wheel lifting during braking, and the front wheel lifting during acceleration.

In other words, the present disclosure proposes a mechanism for providing a good compromise for the weight distribution of the user about the scooter, and more particularly a mechanism for defining a weight distribution of the user about the scooter.

Optionally, no more than 95% of each foot platform overlaps the rear wheel. In some examples, no more than 90% of each foot platform overlaps the rear wheel. In other examples, no more than 80% of each foot platform overlaps the rear wheel. In yet other examples, no more than 50% of each foot platform overlaps the rear wheel. In yet further examples, no more than 20% of each foot platform overlaps the rear wheel. In yet further examples, no more than 10% of each foot platform overlaps the rear wheel.

Optionally, no less than 2% of each foot platform overlaps the rear wheel. In some examples, no less than 5% of each foot platform overlaps the rear wheel. In some examples, no less than 10% of each foot platform overlaps the rear wheel. In other examples, no less than 20% of each foot platform overlaps the rear wheel, e.g. no less than 30% of each foot platform overlaps the rear wheel.

Accordingly, according to various examples, the amount of the foot platform that overlaps the rear wheel may be between: 2% to 95%; 2% to 90%; 2% to 80%; 2% to 50%; 2% to 20%; 2% to 10%; 5% to 95%; 5% to 90%; 5% to 80%; 5% to 50%; 5% to 20%; 5% to 10%; 10% to 95%; 10% to 90%; 10% to 80%; 10% to 50%; 10% to 20%; 20% to 95%; 20% to 90%; 20% to 80%; 20% to 50%; 30% to 95%; 30% to 90%; 30% to 30%; or 30% to 50%.

These embodiments provide a good balance between a fore and aft position for the user, to provide a good balance of weight distribution between the front and rear wheel.

It will be appreciated that just as each foot platform overlaps the rear wheel, so the rear wheel overlaps each foot platform. In this disclosure, the foot platform does not overlap the entirety of the rear wheel. Similarly, in embodiments, the rear wheel does not overlap the entirety of each foot platform.

Accordingly, in some examples, no more than 95% of the rear wheel overlaps each foot platform. In some examples, no more than 90% of the rear wheel overlaps each foot platform. In other examples, no more than 80% of the rear wheel overlaps each foot platform. In yet other examples, no more than 50% of the rear wheel overlaps each foot platform. In yet other examples, no more than 20% of the rear wheel overlaps each foot platform. In yet other examples, no more than 10% of the rear wheel overlaps each foot platform.

Optionally, no less than 2% of the rear wheel overlaps each foot platform. In some examples, no less than 5% of the rear wheel overlaps each foot platform. In some examples, no less than 10% of the rear wheel overlaps each foot platform. In other examples, no less than 20% of the rear wheel overlaps each foot platform. In yet other examples, no less than 30% of the rear wheel overlaps each foot platform.

Thus, according to various examples, the amount of the rear wheel that overlaps each foot platform may be between: 2% to 95%; 2% to 90%; 2% to 80%; 2% to 50%; 2% to 20%; 2% to 10%; 5% to 95%; 5% to 90%; 5% to 80%; 5% to 50%; 5% to 20%; 5% to 10%; 10% to 95%; 10% to 90%; 10% to 80%; 10% to 50%; 10% to 20% 20% to 95%; 20% to 90%; 20% to 80%; 20% to 50%; 30% to 95%; 30% to 90%; 30% to 80%; or 30% to 50%.

In some examples, the foot platforms are inclined with respect to the horizontal (when both front and rear wheels make contact with a horizontal ground surface). For example, the foot platforms may be inclined by between 1° and 20° with respect to the horizontal, e.g. between 1° and 10° or between 1° and 3° (e.g. 2°). A foot platform inclined to the horizontal can lead to improved posture, e.g. encouraging the user to bend their knees, leading to better performance over obstacles or rough terrain, due to the natural damping effect of the human anatomy).

A foot platform that is inclined away from the front wheel may also encourage the user to “sit-back” during deceleration or braking, e.g. to brace themselves against the foot platform. This approach can improve a confidence of the user under braking, reducing the likelihood that the user will panic (e.g. believe they are to be thrown forward), and also encourage the user to shift their weight towards a rear of the scooter, to counter act an effective shift in weight towards a front of the scooter caused by deceleration or braking.

Furthermore, inclined foot platforms further modify the position of the center of mass of the motorized kick scooter (when transporting a user), as the incline will modify the center of gravity of the user.

The foot platforms can be inclined towards the front wheel or away from the front wheel. The inclination has a similar effect in either direction.

In some embodiments, the (vertical) distance d₁ between each foot platform surface and the ground surface 190 (during operation of the motorized kick scooter) is no less than 0.1 times, e.g. no less than 0.2 times, e.g. no less than 0.35 times the diameter of the rear wheel.

This approach recognizes that a higher center of gravity increases an ease of leaning the motorized scooter to perform a turn.

To provide a good balance/compromise between providing a center of gravity that provides a motorized kick scooter that is easy to roll, whilst remaining stable and avoiding unintentional roll, in some examples, the distance between the ground surface and the foot platform surface of each foot platform, whilst the motorized kick scooter is transporting a user across the ground surface, is between 0.1 and 0.75 times, e.g. between 0.35 and 0.6 times, the diameter of the rear wheel.

In some embodiments, a distance d₃ between a lowermost part of each foot platform and the ground surface 190 is more than 0.1 times the diameter d₂ of the wheel, preferably more than 0.2 times the diameter d₂ of the wheel, and more preferably more than 0.3 times the diameter of the wheel.

This approach facilitates increased ease in leaning of the motorized scooter during a turn by increasing the gap between the foot platform and the ground, e.g. to reduce the likelihood that the foot platform will come into contact with the ground surface during a turn.

This approach may also provide additional space for placement of other components for the motorized scooter, e.g. battery arrangements, motor arrangements, control boards and the like.

The skilled person would be capable of appropriately selecting a thickness of the foot platform. As a working example, the foot platforms may each have a thickness of around 25 mm, which (if the foot platform is made of aluminum, steel or other suitable material) provides sufficiently stable support for a user (e.g. without buckling).

FIG. 3 also illustrates a positional relationship between the first part/end of the foot platform(s) 151B, 152B, i.e. the part of the foot platform closest to the front wheel of the scooter, and the wheels 11, 12. In particular, each foot platform is also positioned such that a distance d_{f} between the first/end part 151B, 152B of each foot platform and the front wheel is more than or equal to the distance dᵣ between the first part of each foot platform and the rear wheel. This concept is advantageous for improved positioning of the user, e.g. to ensure that the user is positioned towards the rear of the motorized scooter.

FIG. 3 clearly illustrates how: the distance d_{f} between the first part of each foot platform and the front wheel may be a distance between a vertical plane in which a rearmost part of the front wheel lies and a vertical plane in the first part of the foot platform lies; and the distance between the first part of the foot platform and the rear wheel may be a distance between the vertical plane in which the first part of the foot platform lies and a vertical plane in which the frontmost or foremost part of the rear wheel lies.

In other words, both the distance d_{f} and the distance dᵣ may be a horizontal distance.

In preferable examples, the distance d_{f} between the first part of each foot platform and the front wheel is between 1 and 2 times greater than the distance dᵣ between the first part of each foot platform and the rear wheel, and preferably between 1 and 1.5 times greater than the distance between the first part of each foot platform and the rear wheel.

Although not described or illustrated in detail, it will be apparent that the motorized kick scooter 10 further comprises components for powering and/or controlling one or more of the wheels of the motorized kick scooter. Thus, the motorized kick scooter may further comprise one or more electric motors (which may be formed in a wheel or externally to the wheel), a battery arrangement (for powering the electric motor(s)), control circuitry and/or a user interface for enabling a user to control a speed of the motorized kick scooter.

By way of example, the motorized kick scooter may further comprise a user interface for receiving a first user input indicative of a desired speed of the motorized kick scooter. The user interface may comprise a throttle lever (or twistgrip) and optionally a brake lever, wherein activation of the throttle lever/twistgrip indicates a desired speed or increase in speed (with activation of the optional brake lever indicating a desired reduction in speed). The user interface is preferably positioned in/on the handle for ease of access and control by the user riding the motorized kick scooter.

The operation and configuration of such elements is standard practice in the art of motorized kick scooters, and the skilled person would readily envisage various mechanisms for implementing such elements. However, the presence of such control/power elements is not essential to achieving the underlying concept of the present disclosure, and have therefore not been described in detail.

The components of the motorized kick scooter may be made from any suitable material, e.g. steel, aluminum, carbon fiber, plastics and so on. The skilled person would be readily capable of adapting the motorized kick scooter accordingly.

Although above embodiments illustrate only a single front and rear wheel, some embodiments may comprise more than one front and/or rear wheel. Steering mechanisms and/or motorized arrangements can be adapted accordingly. In examples where the motorized kick scooter comprises more than one rear wheel, the foot platforms may be placed on either side of the complete set of (all) wheels or either side of a single wheel or a subset of the wheels.

In the above described embodiments, either the front wheel or the rear wheel may be motorized.

Preferably, (only) the front wheel is motorized. The elements required to motorize a wheel typically have a relatively large weight. By motorizing the front wheel and positioning the user to partly overlap the rear wheel, the weight distribution about the motorized kick scooter can be made more even, improving an average traction about the wheel of the motorized scooter, and thereby its efficiency and operation.

In some examples, the first foot platform is connected to the lower framework via a first folding mechanism, that allows the first foot platform to fold with respect to the lower framework; and the second foot platform is coupled to the lower framework via a second folding mechanism, that allows the second foot platform to fold with respect to the lower framework.

Thus, the foot platforms may be foldable.

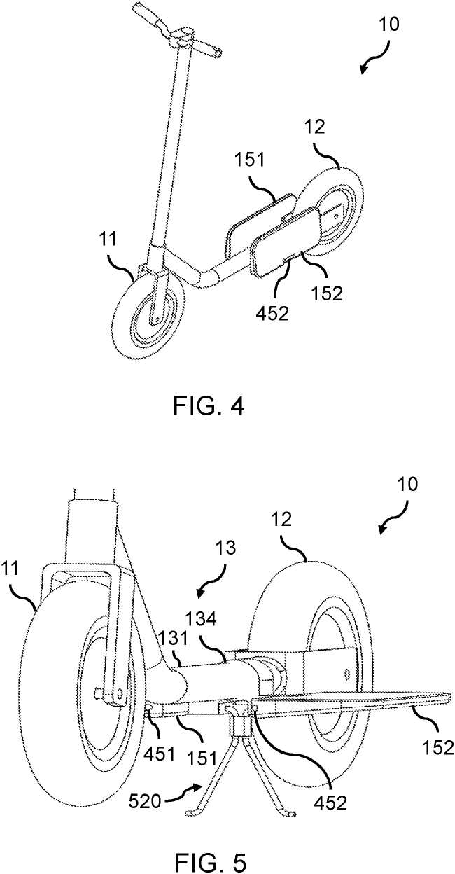

FIG. 4 illustrates an embodiment of a motorized kick scooter 10 in which the foot platforms 151, 152 are foldable. The foot platforms are illustrated in the folded configuration. When unfolded, the motorized kick scooter may appear as illustrated in FIG. 1.

The foldable foot platforms are configured to fold upwardly (i.e. away from a ground surface when the front 11 and rear 12 wheels make contact with the ground surface). This helps to cover and protect the foot platform surface (upon which the user stands) from damage, e.g. whilst the motorized kick scooter is being stored.

As previously explained, each foot platform is made foldable by connecting the first 151 and second 152 foot platforms to the lower framework by respective first and second 452 folding mechanisms. Only the second folding mechanism 452 is visible in FIG. 4, and is embodied as a hinge or similar mechanism.

Other approaches for stowing or folding a foot platform would be apparent to the skilled person.

FIG. 5 provides a floor-level view of a motorized scooter 10 according to some embodiments of the invention. The lower framework 13 further comprises a reinforced support 134. The first 151 and second 152 foot platforms are coupled to this reinforced support. Provision of a reinforced support increases the stability of the foot platforms with respect to the lower framework.

Different approaches for providing a reinforced support 134 will be apparent to the skilled person, for example, providing additional material (as illustrated), providing alternative, stronger material and so on.

In the illustrated example, the reinforced support 134 comprises a collar of material that wraps around the strut 131 of the lower framework, extending slightly below the strut 131 of the lower framework to provide a mounting point for the first and second foot platforms. The reinforced support 134 may be integrally formed with the strut 131, e.g. formed in a same manufacturing process and of the same material, or may be a separately manufactured element mounted on the strut.

In other examples, the reinforced support is part of the strut itself.

The foot platforms 151, 152 may be foldable with respect to the reinforced support 134. That is, each foot platform may be connected to the reinforced support by a respective folding mechanism 451, 452, such as a hinge. FIG. 5 illustrates both a first foldable mechanism 451, for connecting the first foot platform 151 to the lower framework 13 (here: at the reinforced support 134) and a second foldable mechanism 452 for connecting the second foot platform to the lower framework 13 (here: at the reinforced support 134). It is not essential that the foot platforms are foldable (when providing a reinforced support), although it is advantageous for at least improved compactness and protectiveness.

FIG. 5 further illustrates another optional feature of the invention. In particular FIG. 5 illustrates an (optional) stand 520 operable in a first mode, in which the stand couples the motorized kick scooter to the ground surface to prevent or reduce a roll of the motorized kick scooter; and a second mode, in which the stand does not couple the motorized kick scooter 10 to the ground surface to allow a roll of the motorized kick scooter.

The stand 520 is coupled to the reinforced support 134 of the lower framework. This approach recognizes that the structural reinforced support for the first and/or second foot platforms (the reinforced support) provides a good structural point for stabilizing the product when it is not being ridden. This embodiment thereby increases a structural stability of the stand and reduces a likelihood that the stand (or its point of connection to the motorized kick scooter) will break.

The stand may comprise, as illustrated, a component that rotates between two orientations to switch between the two modes of operation. Thus, the stand comprises a rotating mechanism to allow the stand to rotate between a first orientation, in which the stand operates in the first mode, and a second orientation, in which the stand operates in the second mode.

In particular, the stand may comprise two protruding elements that each make contact with the ground surface. The distance between the protruding elements (at least when in contact with the ground surface) may be greater than a width of the front and/or rear wheels. This approach improves a stability of the motorized kick scooter by opposing a roll of the motorized scooter in either direction.

However, other forms of stand would be apparent to the skilled person (e.g. a single protruding element, or a single, wide protruding element (whose contact patch with the floor is wider than a width of the front and/or rear wheel). Moreover, other, non-rotating forms of stand could be used in the present invention, e.g. a telescopic stand or the like.

The illustrated stand 520 is a center stand. In this way, the stand 520 supports or maintains the motorized kick scooter in an upright/vertical position or orientation when engaged with a ground surface. This reduces a footprint occupied by the motorized kick scooter, e.g. during storage or at rest.

The illustrated stand 520 is connected to an underside of the lower framework. This reduces a horizontal extent of the scooter during storage.

In some embodiments, the stand may be configured to, when in the second mode, lift the front and/or rear wheel of the motorized kick scooter from the ground surface. This approach reduces the likelihood that the motorized kick scooter will be able to roll (e.g. roll away) during storage.

This embodiment can be achieved through use of a sufficiently long stand that lifts a wheel when the stand makes contact with the ground surface.

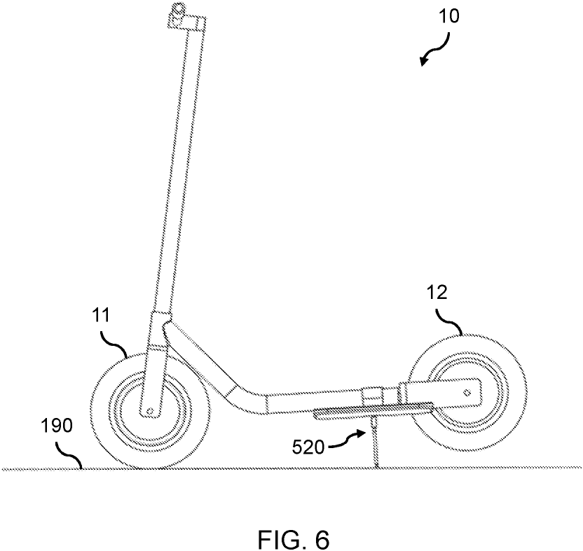

FIG. 6 illustrates an example of this embodiment, in which the stand 520 lifts the rear wheel 12 from the ground surface 190 when operating in the second mode.

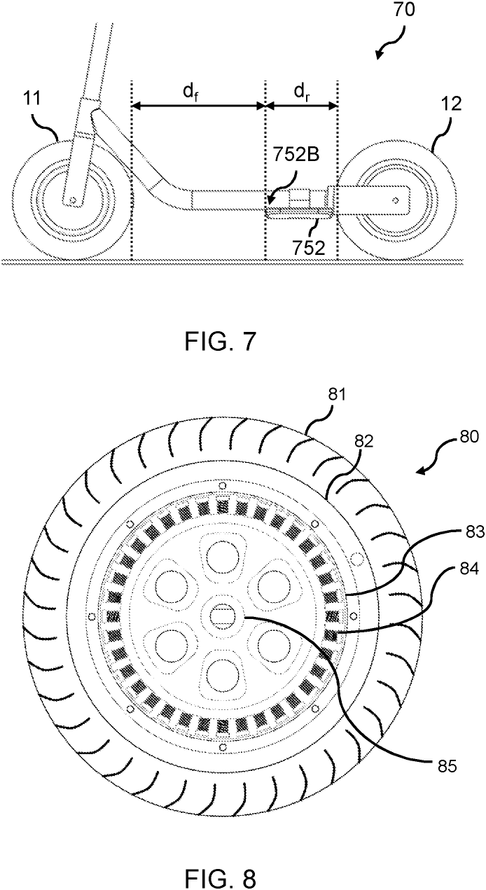

FIG. 7 illustrates a motorized kick scooter 70 according to another embodiment, which is outside the scope of the presently claimed invention. The motorized kick scooter 70 differs from the motorized kick scooter previously described in that the foot platforms do not overlap the rear wheel 12.

Rather, the motorized kick scooter 70 relies upon appropriate positioning of the fore end of each foot platform. In particular, each foot platform 752 is also positioned such that a distance d_{f} between the first/end part 752B of each foot platform 752 and the front wheel 11 is more than or equal to the distance dᵣ between the first part of each foot platform and the rear wheel. The first end/part of a foot platform is the part/end of the foot platform closest to the front wheel.

In preferable examples, the distance d_{f} between the first part of each foot platform and the front wheel is between 1 and 2 times greater than the distance dᵣ between the first part of each foot platform and the rear wheel, and preferably between 1 and 1.5 times greater than the distance between the first part of each foot platform and the rear wheel.

All other components of the motorized kick scooter may be as previously described, and may include any optional features and/or modifications described in previous examples (e.g. with reference to FIGS. 1 to 6). They will not be repeated for the sake of conciseness.

There is further proposed a motorized kick scooter for transporting a user across a ground surface. The motorized kick scooter may comprise: a front wheel; a rear wheel, wherein at least one of the front and rear wheels are motorized; a lower framework coupling the front wheel to the rear wheel; a handle arrangement configured to support a hand of the user and facilitate control of a direction of the front wheel with respect to the lower framework; and a foot platform arrangement coupled to the lower framework, the foot platform arrangement comprising: a first foot platform configured to support a first foot of the user on a first foot platform surface, the first foot platform being positioned on a first side of the rear wheel; a second, separate foot platform configured to support a second foot of the user on a second foot platform surface, the second foot platform being positioned on a second, different side of the rear wheel, wherein each foot platform: has a length of no more than 600 mm; is positioned such that a distance between the ground surface and the foot platform surface of each foot platform, whilst the motorized kick scooter is transporting a user across the ground surface, is less than a diameter of the rear wheel, and is positioned such that at least a first part of each foot platform, being a part of a foot platform closest to the front wheel, lies between the front wheel and the rear wheel.

The motorized kick scooter is also configured such that each foot platform: is positioned to overlap only a part of the rear wheel; and is positioned such that a distance between the first part of each foot platform and the front wheel is more than or equal to the distance between the first part of each foot platform and the rear wheel.

The present disclosure also recognizes that a further advantage of the disclosed motorized kick scooter is that features that rely on interactions with the user can be improved, as the proposed foot platform arrangement means that the position of the user can be predicted.

As an example, a motorized kick scooter may comprise a light projection system configured to project light on to a user of the motorized scooter. A light projection system improves the visibility of the user during low ambient light conditions, e.g. at night or in fog.

As the position of the user will be known, features of the light projection system can be made more specific to the user. For example, a spread of light or an angle of light emitted by the light projection system may be configured based upon the position of the foot platform arrangement relative to the lower framework.

As an example only, the spread of light may be made more narrow (i.e. more focused light), as there is a reduced need to provide a broad range of light output as the position of the user of the motorized scooter can be predicted. A reduced spread of light can either be used to improve the visibility of the user (e.g. by increasing an average light intensity incident on the user) or reduce a power consumption required to provide a same average light intensity incident on the user (e.g. as less power is required to provide a same light intensity over a narrower range).

Thus, one or more parameters of light output by a light projection system may be dependent on the position of the foot platform arrangement relative to the lower framework. The present invention therefore recognizes that the proposed foot platform is particularly advantageous when used alongside a light projection system.

FIG. 8 illustrates an example of a motorized wheel 80 for use in a motorized kick scooter according to an embodiment. Other examples of suitable motorized wheels will be readily apparent to the skilled person, e.g. incorporating a geared wheel or a belt-driven wheel.

The motorized wheel can act as the front wheel and/or the rear wheel.

The motorized wheel 80 comprises a tire 81, a rim 82, a rotor 83, a stator 84, and an axle 85. The tire 81 is adapted for contacting a ground surface. The rim 82 is adapted to mount the tire thereon. The rotor 83 is fixedly connected to the rim 82 and is magnetically coupled to the stator 84, so as to be rotatable about the stator 84. Here, the rotor comprises a ring of permanent magnets. The stator 84 comprises a ring of electromagnetic windings, the current through which can be controlled to thereby control the torque applied to the rotor 83, and thereby the propulsive force applied by the motorized wheel. The rotor 83 is mounted on the axle 85 by at least one bearing (not shown), the bearings allowing the rotor 83 to rotate about the axle 85. The stator is fixedly coupled to the axle 85.

In this way, the motorized wheel can be controlled by controlling a current flowing through the stator 84 to control a rotation of the rotor (and thereby the rim and the tire). A motor control unit (not shown) may control the operation of the stator 84, e.g. responsive to a user input provided at a user interface (e.g. positioned on the handle arrangement).

The motorized wheel can be controlled to propel forward by applying a torque about the rotor 83 in a desired direction of travel. This is performed by sequentially applying current through the ring of electromagnetic windings in a particular pattern, as would be well known to the skilled person.

A braking force can be applied to the wheel by either applying torque, in the manner previously described, to oppose the direction of travel or by continuously running a current through at least one coil to oppose or resist rotation of the rotor 83 about the stator 84. Other approaches will be apparent to the skilled person, e.g. using a disc or friction brake. A braking force may be applied in response, for example, to a user input provided at a user interface (e.g. positioned on the handle arrangement).

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. If the term “adapted to” is used in the claims or description, it is noted the term “adapted to” is intended to be equivalent to the term “configured to”. Any reference signs in the claims should not be construed as limiting the scope.

1. A motorized kick scooter for transporting a user across a ground surface, the motorized kick scooter comprising:
a front wheel;
a rear wheel, wherein at least one of the front wheel or the rear wheel is motorized;
a lower framework coupling the front wheel to the rear wheel;
a handle arrangement configured to support a hand of the user and facilitate control of a direction of the front wheel with respect to the lower framework; and
a foot platform arrangement coupled to the lower framework, the foot platform arrangement comprising:
a first foot platform configured to support a first foot of the user on a first foot platform surface, the first foot platform being positioned on a first side of the rear wheel;
a second, separate foot platform configured to support a second foot of the user on a second foot platform surface, the second foot platform being positioned on a second, different side of the rear wheel,
wherein each foot platform:
has a length (L₁) of no more than 600 mm;
is positioned to overlap only a part of the rear wheel;
is positioned such that a distance (d₁) between the ground surface and the foot platform surface of each foot platform, whilst the motorized kick scooter is transporting the user across the ground surface, is less than a diameter (d₂) of the rear wheel;
is positioned such that at least a first part of each foot platform, being a part of a foot platform closest to the front wheel, lies between the front wheel and the rear wheel; and
is positioned such that a distance (d_{f}) between the first part of each foot platform and the front wheel is more than or equal to the distance (dᵣ) between the first part of each foot platform and the rear wheel.

2. The motorized kick scooter of claim 1, wherein each foot platform is positioned such that such that a distance (dᵣ, d_{f}) between the first part of each foot platform and the front wheel is between 1 and 2 times greater than the distance between the first part of each foot platform and the rear wheel.

3. The motorized kick scooter of claim 2, wherein each foot platform is positioned such that a distance (dᵣ, d_{f}) between the first part of each foot platform and the front wheel is between 1 and 1.5 times greater than the distance between the first part of each foot platform and the rear wheel.

4. The motorized kick scooter of claim 1, wherein:
the distance (d_{f}) between the first part of each foot platform and the front wheel is a distance between a vertical plane in which a rearmost part of the front wheel lies and a vertical plane in the first part of the foot platform lies; and
the distance (dᵣ) between the first part of the foot platform and the rear wheel is a distance between the vertical plane in which the first part of the foot platform lies and a vertical plane in which the frontmost or foremost part of the rear wheel lies.

5. The motorized kick scooter of claim 1, wherein each foot platform has a length (L₁) of no more than 400 mm, and preferably no more than 300 mm.

6. The motorized kick scooter of claim 1, wherein each foot platform is positioned in parallel to the rear wheel.

7. The motorized kick scooter of claim 1, wherein:
the first foot platform is connected to the lower framework via a first folding mechanism, that allows the first foot platform to fold with respect to the lower framework; and
the second foot platform is coupled to the lower framework via a second folding mechanism, that allows the second foot platform to fold with respect to the lower framework.

8. The motorized kick scooter of claim 1, wherein the lower framework comprises a reinforced support to which the first foot platform and/or the second foot platform are coupled.

9. The motorized kick scooter of claim 8, further comprising a stand operable in:
a first mode, in which the stand couples the motorized kick scooter to the ground surface to prevent or reduce a roll of the motorized kick scooter; and
a second mode, in which the stand does not couple the motorized kick scooter to the ground surface to allow a roll of the motorized kick scooter,
wherein the stand is coupled to the reinforced support of the lower framework.

10. The motorized kick scooter of claim 9, wherein the stand comprises a rotating mechanism to allow the stand to rotate between a first orientation, in which the stand operates in the first mode, and a second orientation, in which the stand operates in the second mode.

11. The motorized kick scooter of claim 1, wherein each foot platform has a width (W₁) of no more than 250 mm.

12. The motorized kick scooter of claim 11, wherein each foot platform has a width (W₁) of no more than 150 mm.

13. The motorized kick scooter of claim 1, wherein no more than 80% of each foot platform overlaps the rear wheel.

14. The motorized kick scooter of claim 13, wherein no more than 50% of each foot platform overlaps the rear wheel.

15. The motorized kick scooter of claim 14, wherein no more than 20% of each foot platform overlaps the rear wheel.

16. The motorized kick scooter of claim 1, wherein no more than 80% of the rear wheel overlaps each foot platform.

17. The motorized kick scooter of claim 16, wherein no more than 50% of the rear wheel overlaps each foot platform.

18. The motorized kick scooter of claim 17, wherein no more than 20% of the rear wheel overlaps each foot platform.

19. The motorized kick scooter of claim 1, wherein each foot platform is positioned such that a distance (d₁) between the ground surface and the foot platform surface of each foot platform, whilst the motorized kick scooter is transporting the user across the ground surface, is less than 0.75 times the diameter (d₂) of the rear wheel.

20. The motorized kick scooter of claim 1, wherein the front wheel is motorized.

21. The motorized kick scooter of claim 1, further comprising a light projection system configured to project light onto the user of the motorized kick scooter.
